(19) United States
(12) Patent Application Publication
(10) Pub. No.: US 2017/0158130 A1
(43) Pub. Date: Jun. 8, 2017

(54) SYSTEM TO DETECT VEHICLE LAMP PERFORMANCE

(71) Applicant: Dura Operating, LLC, Auburn Hills, MI (US)

(72) Inventors: Rajashekhar Patil, Ypsilanti, MI (US); Gordon M. Thomas, Beverly Hills, MI (US); Aaron E. Thompson, Grand Blanc, MI (US)

(21) Appl. No.: 14/958,310

(22) Filed: Dec. 3, 2015

(51) Int. Cl. B60Q 11/00; G07C 5/08

(52) U.S. Cl. CPC B60Q 11/005; G07C 5/0808; G07C 5/0816

(57) ABSTRACT

A system to detect or determine vehicle lamp performance and a method using the system is described. The system includes a first optical sensor having a field of view which includes the location of a vehicle lamp or into which light from a vehicle lamp is emitted, the optical sensor providing an output indicative of vehicle lamp performance; and a controller in communication with the first optical sensor to receive the output, the controller including at least one processor adapted to analyze the optical sensor output and provide a control output at least when the optical sensor output is indicative that the vehicle lamp performance is below a threshold.

### TECHNICAL FIELD

The present disclosure relates to a system to detect vehicle lamps or light performance, and more particularly, it relates to using a vehicle optical light sensing system to determine a degradation in vehicle lamp performance.

### BACKGROUND

While advancements in technology have extended the operating life of bulbs and LEDs for vehicle lamps in recent years, the operating life is still limited. Ultimately, the bulb or LED burns out or fails for other reasons. When this occurs, the driver of the vehicle may be unaware that one or more lamps are not operating correctly or at all.

### SUMMARY

In at least some implementations, a system to detect or determine vehicle lamp performance is described. The system includes a first optical sensor having a field of view which includes the location of a vehicle lamp or into which light from a vehicle lamp is emitted, the optical sensor providing an output indicative of vehicle lamp performance; and a controller in communication with the first optical sensor to receive the output, the controller including at least one processor adapted to analyze the optical sensor output and provide a control output at least when the optical sensor output is indicative that the vehicle lamp performance is below a threshold.

In at least some other implementations, a system to detect or determine vehicle lamp performance is described. The system includes a plurality of optical sensors adapted to monitor an area around a vehicle which includes at least one vehicle lamp or light emitted therefrom into the area around the vehicle; and a controller that is couplable to the plurality of optical sensors, the controller comprising memory and at least one processor, wherein the memory is a non-transitory computer readable medium having instructions stored thereon for determining at the controller a degradation in vehicle lamp performance and providing an alert signal from the controller, wherein the instructions comprise: receiving one or more images from one of the plurality of optical sensors, at least a portion of the one or more images comprising a region of interest associated with the at least one vehicle lamp or the light emitted therefrom; determining an overall intensity of the one or more images; and when the overall intensity is less than a predetermined threshold, then: using the one or more images, determining whether vehicle lamp performance is degraded; and when vehicle lamp performance is degraded, then providing the alert signal.

In at least some other implementations, a method of determining a vehicle lamp performance at a controller in a vehicle is described. The method includes: receiving at the controller at least one image from an optical sensor wherein the at least one image comprises a region of interest associated with a vehicle lamp; determining at the controller an intensity of the region of interest; comparing the determined intensity to a threshold; and providing an alert signal from the controller when the intensity is below the threshold.

Other embodiments can be derived from combinations of the above and those from the embodiments shown in the drawings and the descriptions that follow.

### BRIEF DESCRIPTION OF THE DRAWINGS

The following detailed description of preferred implementations and best mode will be set forth with regard to the accompanying drawings, in which:

FIG. 1 is a schematic view of a vehicle having an optical light sensing system, the vehicle being positioned on a vehicle camera calibration pad;

FIG. 2 is a perspective view of an area in front of the vehicle shown in FIG. 1, from the point of view of a camera mounted in a front grill of the vehicle;

FIG. 3 is a perspective view of an area in rear of the vehicle shown in FIG. 1, from the point of view of a camera mounted in a trunk of the vehicle;

FIG. 4 is a perspective view of an area on a driver's side of the vehicle shown in FIG. 1, from the point of view of a camera mounted in a driver's side mirror of the vehicle;

FIG. 5 is a perspective view of an area on a passenger's side of the vehicle shown in FIG. 1, from the point of view of a camera mounted in a passenger's side mirror of the vehicle; and

FIG. 6 is a flow diagram illustrating a method of determining whether performance of a vehicle lamp is degraded.

### DETAILED DESCRIPTION

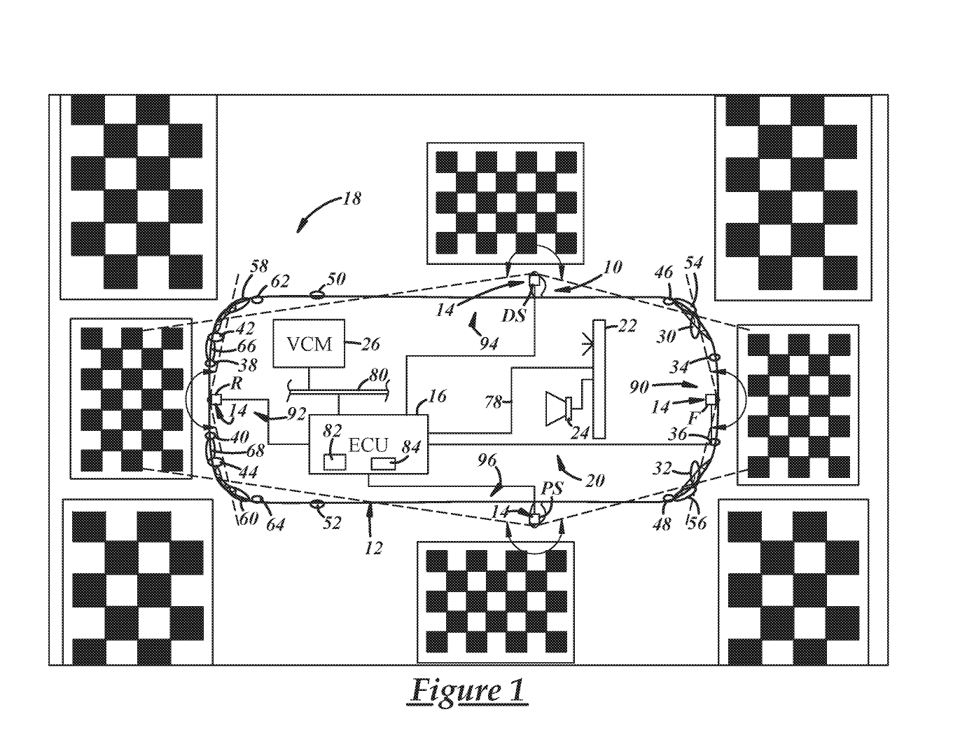

Referring in more detail to the drawings, FIG. 1 illustrates an embodiment of an optical light sensing system 10 for a vehicle 12 that comprises one or more optical sensors or detectors, such as cameras 14, and an electronic control unit (ECU) or controller 16 in communication with the camera(s). The light sensing system 10 may be integrated with or embedded in the vehicle as original equipment and may assist in providing a variety of functions including determining the performance of at least one vehicle lamp 18—e.g., determining whether a light source within a vehicle headlamp, stop lamp, or turn indicator has failed. In determining lamp performance, the ECU 16 may monitor one or more exterior vehicle lamps by receiving and processing image data received from the camera(s) 14. As will be described more below, image processing techniques may be used to determine whether a particular vehicle lamp is functioning properly which in at least some implementations includes determining that the lamp is emitting at least a threshold amount of light.

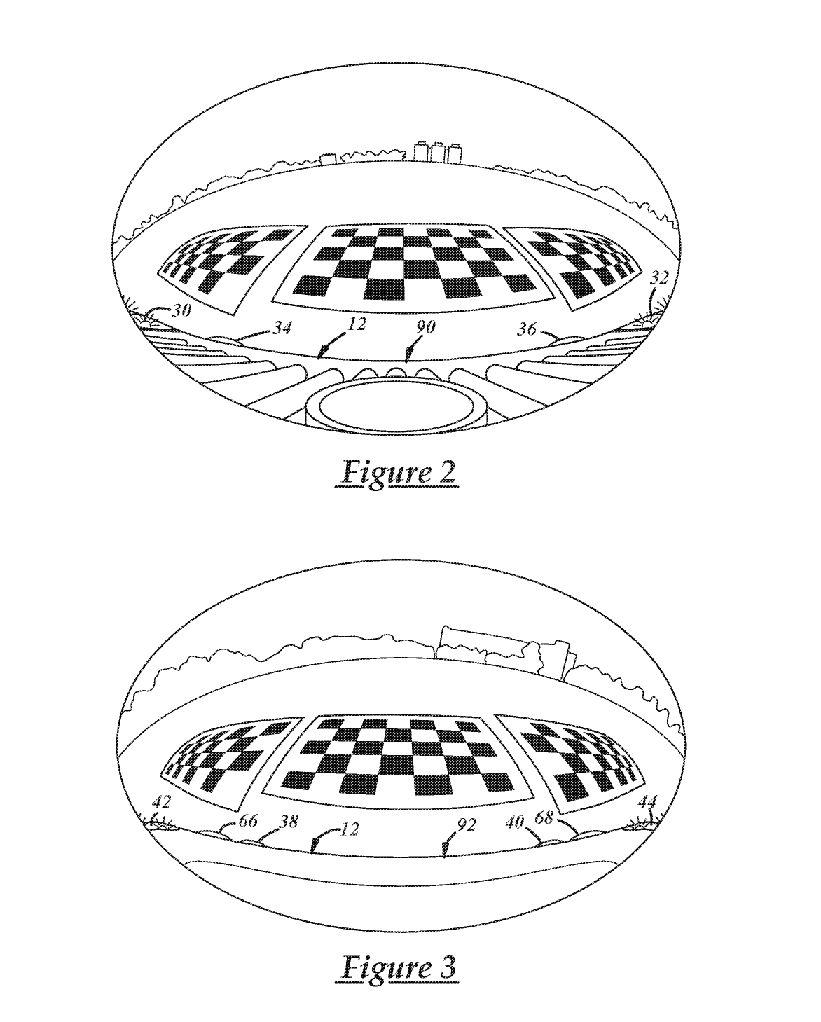

As shown in FIG. 1, the vehicle 12 is depicted in the illustrated embodiment as a passenger car, but it should be appreciated that any other vehicle including trucks, sports utility vehicles (SUVs), recreational vehicles (RVs), marine vessels, aircraft, etc., can also be used. Vehicle 12 may include the exterior vehicle lighting system 18, a variety of other vehicle electronics 20 (e.g., including an instrument panel 22, an audio system 24, and one or more vehicle control modules (VCMs) 26 (only one is shown)), and the light sensing system 10. The vehicle 12 is shown located on a vehicle camera calibration pad to better illustrate the points of view of cameras 14, which points of view are illustrated in FIGS. 2-5 and explained in greater detail below.

In FIG. 1, the vehicle lighting system 18 may comprise a variety of lamps for illumination and vehicle-to-vehicle indication (e.g., for conspicuity, signaling, and/or identification). Non-limiting examples of illumination lamps include head lamps 30, 32, front fog lamps 34, 36, rear fog lamps 38, 40, reversing (or backup) lamps 42, 44, and the like. Non-limiting examples of indication lamps include front position lamps 46, 48 (e.g., parking lamps), side-marker lamps 50, 52, turn-signal lamps 54, 56, 58, 60, rear position lamps 62, 64 (e.g., parking lamps), brake or stop lamps 66, 68, and the like. Of course, the reversing lamps 42, 44 could also be considered indication lamps. While the vehicle 12 in FIG. 1 has each of these lamps, this is done for illustrative purposes only and is not required. One or more of these vehicle lamps may be actuated by a vehicle user and/or may be controlled automatically by one or more VCMs 26 (e.g., a lighting control module). As used herein, a vehicle user may be a vehicle driver or passenger. Any suitable vehicle lamps, wiring, user-actuated control switch(es), lighting control modules, etc. can be used, as desired.

Other vehicle electronics 20 include the instrumental panel 22 and/or audio system 24 which may be adapted to provide visual alerts, audible alerts, or a combination thereof to the vehicle user. Non-limiting examples of visual alerts include an illuminated icon on the instrument panel 22, a textual message displayed on the instrument panel 22, an alert on a vehicle user's mobile device (not shown), and the like. Non-limiting examples of audible alerts include rings, tones, or even recorded or simulated human speech. In some implementations, an audible alert may accompany a visual alert; in other implementations it may not. In at least one implementation, the alert may be triggered by the ECU 16—e.g., when the ECU determines a degradation in performance of one or more vehicle lamps, as will be explained in greater detail below. Thus, the ECU 16 may communicate with the instrument panel 22 and audio system 24 via one or more discrete connections 78 (wired or wireless); however, a direct connection is not required. Or for example, these vehicle electronics could be coupled indirectly to ECU 16—e.g., ECU 16 could be coupled to a vehicle control module 26 which in turn is coupled to the instrumental panel 22.

Vehicle electronics 20 also may comprise one or more VCMs 26 configured to perform various vehicle tasks. Non-limiting examples of vehicle tasks include: controlling forward-illumination lamps (e.g., ON/OFF actuation of vehicle headlamps 30, 32, high beam/low beam control, etc.); controlling a vehicle braking system (not shown) (e.g., actuating stop lamps 66-68 when the brake pedal is depressed, etc.); controlling vehicle indication lamps (e.g., actuating front position lamps 46-48, side-marker lamps 50-52, turn signal-lamps 54-60 (as turn signal or hazard indicators), and/or rear position lamps 62-64); and the like. VCMs 26 could be coupled to the ECU 16 via a vehicle communication bus 80. Or in other implementations, discrete electrical connections could be used or any other suitable type of communication link (e.g., optical links, short range wireless links, etc.).

Referring again to FIG. 1, ECU 16 of vehicle camera system 10 comprises memory 82 and one or more processors 84. Memory 82 includes any non-transitory computer usable or computer readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. In at least one embodiment, ECU memory 82 includes an EEPROM device or a flash memory device.

Processor(s) 84 can be any type of device capable of processing electronic instructions including microprocessors, microcontrollers, electronic control circuits comprising integrated or discrete components, application specific integrated circuits (ASICs), and the like. The processor(s) 84 can be a dedicated processor(s)—used only for ECU 16—or it can be shared with other vehicle systems (e.g., VCMs 26). Processor(s) 84 execute various types of digitally-stored instructions, such as software or firmware programs which may be stored in memory 82, which enable the ECU 16 to provide a variety of vehicle services. For instance, processor(s) 84 can execute programs, process data and/or instructions, and thereby carry out at least part of the method discussed herein. In at least one embodiment, processor(s) 84 may be configured in hardware, software, or both: to receive image data from one or more cameras 14; to evaluate the image data and determine whether a luminance of an exterior vehicle lamp is degraded (e.g., lamps 30-68) using an image processing algorithm; and then to generate an alert signal that may be used by the instrument panel 22 and/or audio system 24 to notify the vehicle user of the degradation, as will be explained in greater detail below.

In at least one embodiment, the processor 84 executes an image processing algorithm stored on memory 82. The algorithm may use any suitable image processing techniques, including but not limited to: pixelation, linear filtering, principal components analysis, independent component analysis, hidden Markov models, anisotropic diffusion, partial differential equations, self-organizing maps, neural networks, wavelets, etc.—as those terms are understood by skilled artisans. The algorithm may be used to identify regions of interest in an image or image data, as well as determine relative light intensities within at least a portion of an image or image data, as will be discussed in greater detail below.

The vehicle camera system 10 may be operable with a single camera 14; however, in at least one implementation, a plurality of cameras 14 are used (e.g., four cameras F, R, DS, PS are shown in FIG. 1). In at least one embodiment, the cameras F, R, DS, PS are arranged to enable a view of a significant portion of the vehicle or environment surrounding the vehicle, up to and including a vehicle user surround-view or a 360° view around the vehicle 12. For example, camera F may be mounted in a front region 90 of the vehicle 12 (e.g., in the vehicle grill, hood, or front bumper), camera R may be mounted in a rear region 92 of the vehicle 12 (e.g., on a vehicle rear door, trunk, rear bumper, tailgate, etc.), and cameras DS, PS may be mounted at side regions 94, 96 of the vehicle 12 (e.g., on or around the vehicle side mirrors or any other suitable feature on the driver and passenger sides of the vehicle 12).

Each of the cameras F, R, DS, PS may have similar characteristics, and in one embodiment, the cameras F, R, DS, PS are identical. For example, each of the cameras F, R, DS, PS may have a horizontal field of view (HFOV) of approximately 180° (e.g., using a fisheye lens). In at least one embodiment, the HFOV of each camera F, R, DS, PS may be approximately 185°; however, this is not required and in other implementations, the HFOV could be larger or smaller. The vertical field of view (VFOV) may be narrower and may accommodate any suitable aspect ratio (e.g., 4:3, 16:9, etc.). It should be appreciated that the terms HFOV and VFOV are relative terms; thus, depending upon the orientation of cameras F, R, DS, PS when mounted in the vehicle 12, the HFOV may not be horizontal with respect to the actual horizon and the VFOV may not be vertical with respect thereto. However, in at least one implementation, the HFOV of each camera F, R, DS, PS is horizontal with respect to the actual horizon (see FIGS. 2-5, which are discussed below). The cameras F, R, DS, PS may have any suitable refresh rate (e.g., 30 Hz, 60 Hz, 120 Hz, just to name a few examples). Each of the cameras' depths of field (or effective focus ranges) may be suitable for detecting or resolving features on the vehicle 12, roadway objects, or even other nearby vehicles (e.g., at least between 0 meter to infinity).

In at least one implementation, each camera F, R, DS, PS is digital and provides digital image data to the ECU 16; however, this is not required (e.g., analog video could be processed by ECU 16 instead). Each camera F, R, DS, PS may be configured for day and/or low-light conditions; e.g., in digital camera implementations, an imaging sensor (not shown) of each camera F, R, DS, PS could be adapted to process visible light, near-infrared light, or any combination thereof making each camera F, R, DS, PS operable in day-or night-time conditions. Other optical sensor or camera implementations are also possible (e.g., cameras having thermal imaging sensors, infrared imaging sensors, image intensifiers, etc.). In FIG. 1, cameras F, R, DS, PS are shown each coupled directly to the ECU 16. However, in other implementations, the cameras may be coupled using a communication bus (e.g., bus 80).

FIGS. 2-5 illustrate an image captured by each of the cameras F, R, DS, PS, respectively. The image may be a single image directly from a camera or a stitched or otherwise merged combination of more than one image. The image may be discretely captured by a camera and, in at least one embodiment, the camera is a video camera with a frame rate of 10 frames/second or greater and the image is one frame from the video. For example, FIG. 2 illustrates an image of the front region 90 of vehicle 12 and the ground frontward of the vehicle 12. As will be described in greater detail below, a image of the front region 90 may include a portion of each of the headlamps 30, 32—which will be referred to in the description below as a region of interest. As used herein, a region of interest is at least a portion of an image, or a set or subset of data within an image that pertains to a vehicle lamp (e.g., at least a portion of the entire video frame). As will become apparent in the discussion below, a single image may comprise one or more regions of interest. Further, each region of interest may be categorized as a primary region of interest or a secondary region of interest. In at least one embodiment, the primary region of interest includes an image of a vehicle lamp (20-72) itself, and the secondary region of interest may include an image of light projected from the lamp (20-72) or a reflection of the projected light. For example, FIG. 2 includes several regions of interest—one for each headlamp 30-32 and one for each fog lamp 34-36.

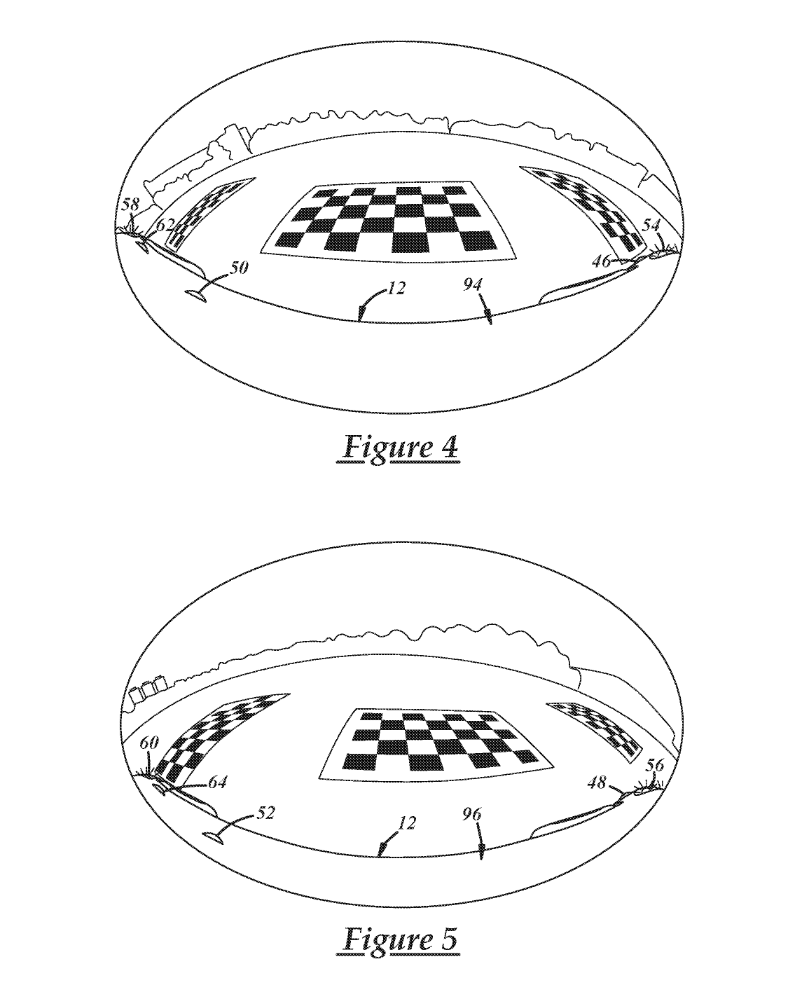

FIG. 3 illustrates an image of the rear region 92 of vehicle 12 and the ground rearward of the vehicle (possible regions of interest include rear fog lamps 38-40, reversing lamps 42-44, and stop lamps 66-68). FIG. 4 illustrates an image of the driver side region 94 of vehicle 12 and the ground along the driver side of the vehicle (possible regions of interest include front position lamp 46, turn-signal lamps 54, 58, rear position lamp 62, and side-marker lamp 50). And FIG. 5 illustrates an image of the passenger side region 96 of vehicle 12 and the ground along the passenger side of the vehicle (possible regions of interest include front position lamp 48, turn-signal lamps 56, 60, rear position lamp 64, and side-marker lamp 52). In each of these examples, the region(s) of interest may differ depending on vehicle body style and position of the camera(s) 14.

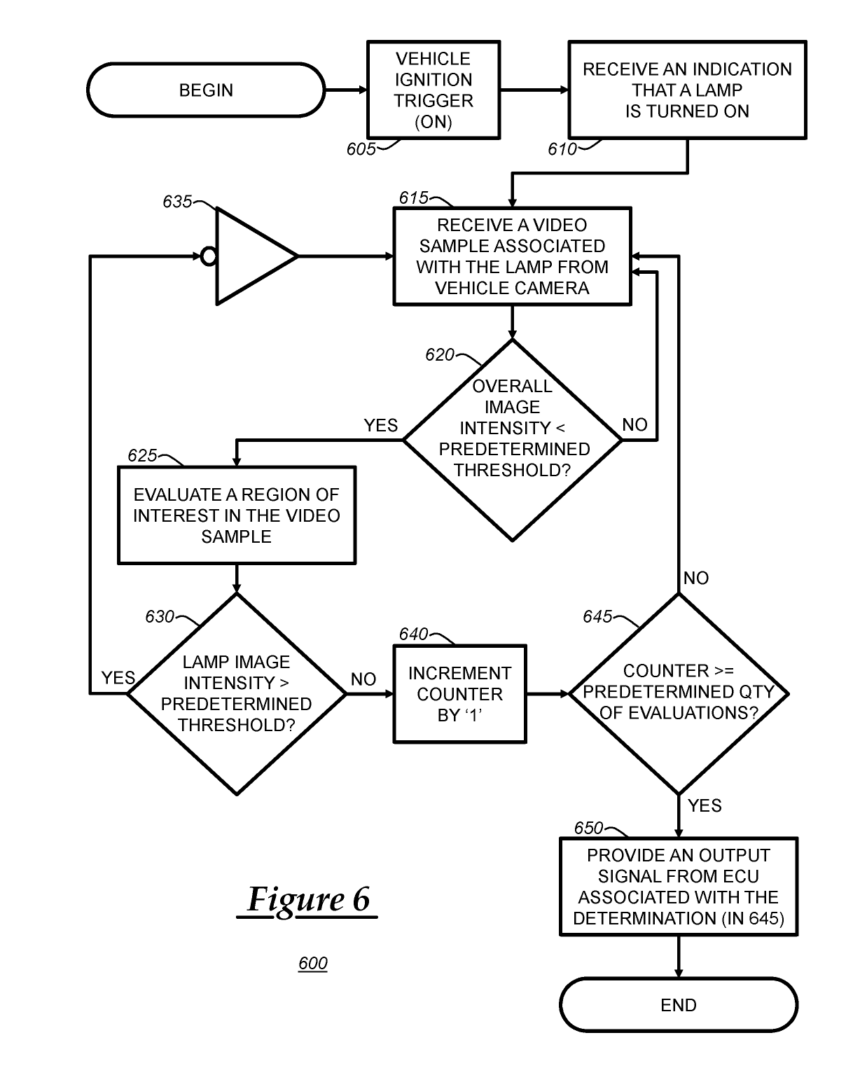

FIG. 6 is a flow diagram illustrating an embodiment of a method 600 for determining whether performance of one of the vehicle lamps 30-72 has become degraded or has malfunctioned. In the method, the ECU 16 makes this determination by the one or more processors 84 receiving input data from the camera(s) 14, lighting system 18, and/or other vehicle electronics 20, executing instructions stored on ECU memory 82 using the received input data, and selectively providing one or more outputs (e.g., to the vehicle electronics 20). In at least one embodiment, prior to the first step of the method 600, the vehicle ignition may be OFF.

In the description which follows, one camera (e.g., camera F) and one vehicle lamp (e.g., headlamp 30) are used as an illustrative example; however, it should be appreciated that any of the other vehicle lamps (32-68) could be evaluated by the ECU 16 using image data from any suitable camera F, R, DS, PS. And for example, image data from camera F also could be used perform a similar evaluation for other vehicle lamps at or near the same time the ECU 16 evaluates headlamp 30—e.g., in the embodiment shown in FIG. 1, image data from camera F could be used to determine the performance of the other headlamp 32 and the front fog lamps 34, 36. Similarly, image data from camera R could be used to could determine the performance of the rear fog lamps 38-40, the reversing lamps 42-44, and the stop lamps 66-68. Similarly, image data from camera DS could be used to determine the performance of the front position lamp 46, the turn-signal lamps 54, 58, the rear position lamp 62, and the side-marker lamp 50. And similarly, image data from camera PS could be used to determine the performance of the front position lamp 48, the turn-signal lamps 56, 60, the rear position lamp 64, and the side-marker lamp 52. In addition, in at least some embodiments (and depending on vehicle body shape), image data from two cameras 14 could be used to evaluate a single vehicle lamp. For example, while not shown in FIG. 1, image data from cameras F and DS could be used to evaluate turn-signal lamp 54. Other examples will be apparent to skilled artisans.

Step 605 may initiate the method 600. In step 605, a vehicle ignition event (e.g., powering vehicle ON) may trigger the performance determination of the vehicle headlamp 30. The trigger may be an input signal (e.g., an electrical signal, an optical signal, a wireless signal, etc.) to the ECU 16 received from a vehicle control module 26. Upon receipt of the input signal, the processor(s) 84 may initiate instructions which may be conditional upon occurrence of the trigger event. In some implementations, this trigger event may occur immediately following the vehicle ignition event, or following other vehicle start-up procedures. This trigger event is merely an example, and other trigger events are possible—e.g., provided the vehicle lighting system 18, vehicle electronics 20, and the vehicle camera system 10 are powered. Next, the method proceeds to step 610.

In step 610, the ECU 16 may receive an indication that vehicle headlamp 30 is activated or turned on. This indication may be an input from the lighting control module 26 and may occur as a result of any suitable actuation of the headlamp 30. For example, the lighting control module 26 automatically could switch the headlamp 30 from an ‘off’ state to the ‘on’ or actuated state (e.g., upon determining that ambient light is below a threshold). Or the vehicle user could manually actuate a switch in the vehicle cabin to change the state of the headlamp 30. In at least one embodiment, the lighting control module 26 may receive no feedback indication from headlamp 30 regarding whether the headlamp 30 is actually projecting light in the actuated state. Following step 610, the method 600 proceeds to step 615.

In step 615, the ECU 16 may receive one or more images or image data from camera F in response to the indication received in step 610. This data may be used to determine the performance of vehicle headlamp 30, as well as for a variety of other purposes. For example, in at least one embodiment, the image data is streamed or otherwise provided to the ECU 16, and the ECU uses the image data to provide warnings to the vehicle user—e.g., generating lane departure warnings, blind spot detection/warnings, etc. In at least one implementation, the primary use or purpose of the camera system 10 is not to detect degradations in exterior vehicle lamps (e.g., 30-68), but instead to provide lane departure warnings and the like. Regardless, it has been discovered that a vehicle camera 14 can be used for secondary purposes as well, such as detecting degradations in the exterior vehicle lamps. Thus, in step 615, the ECU 16 may automatically receive image data from the cameras F, R, DS, PS—e.g., using that data for other camera system purposes—or in some implementations, the ECU 16 may request the image data from the camera(s) F, R, DS, PS at any suitable time specifically for the determining the performance of one or more vehicle lamps 30-68.

In at least one implementation, the image data is streamed to the ECU 16 from the camera F, and the image data comprises a plurality of video samples. As used herein, a video sample comprises one or more images (i.e., one or more video frames) or a segment of image data (e.g., a segment of streaming video). For example, the duration of a video sample may be defined by the time duration of the video or the quantity of images. In at least one embodiment, the desired video sample for determining a degradation of headlamp function may be a quantity of images or be associated with a predetermined time duration (e.g., two minutes). For example, it is contemplated that by processing and analyzing two minutes of image data rather than a shorter increment, the user experience may be improved by minimizing inaccurate warnings (e.g., false positive indications of a vehicle lamp degradation). Of course, two minutes is merely one example; other quantities of images or video samples are contemplated as well.

In step 620, which follows step 615, the ECU 16 may determine whether an overall image intensity of the video sample is less than a predetermined threshold associated with a low-light condition. The image processing algorithm may be executed by processor 84 to determine the overall image intensity, and then the processor 84 may compare the overall image intensity to the predetermined threshold. For example, in digital image processing, the overall image intensity may be an intensity value associated with all pixels in an image. For example, in grayscale implementations, each pixel or group of pixels may be assigned a luminance value or a relative lightness or darkness value and the overall intensity may be determined based on the luminance or relative lightness/darkness of all the pixels (or e.g., most of all the pixels—e.g., all the effective pixels in instances where the lens does not cover the entire sensor array). To further this illustration, in grayscale implementations, numerical values of each pixel or group of pixels may be determined to range from 0 to 255 (highest to lowest intensities, respectively). And in at least one implementation, the overall image intensity is a sum of the values of each pixel or group of pixels. Of course, this is merely one implementation; others exist (e.g., analogous techniques may be used in color implementations). Where the video sample comprises multiple images, the overall intensity value may be an average intensity value of each of these images.

The predetermined threshold, to which the overall image intensity is compared, may be stored in ECU memory 82 (e.g., EEPROM) and be associated with an environmental or ambient intensity (i.e., of the vehicle surroundings). The actual ambient intensity received by the cameras F, R, DS, PS will vary depending on whether the vehicle is in direct sunlight, indirect sunlight (e.g., due to cloud cover or obstructions such as trees, buildings, etc.), subject to artificial lighting, etc., just to name a few examples. In at least one embodiment, the predetermined threshold may be associated with one of a dimly lit environment, a heavy cloud cover environment, a twilight environment (e.g., dusk or pre-dawn), or even darker scenarios.

In step 620, when the overall image intensity of the video sample is less than the predetermined threshold, then the ECU 16 proceeds to evaluate whether the performance of the headlamp 30 is degraded (proceeding to step 625). Alternatively, when the overall image intensity of the video sample is greater than or equal to this predetermined threshold, then the method loops back and repeats step 615, as described above. By selecting a video sample associated with a low-light condition, the processor 84 further minimizes the likelihood of a false positive determination when using the image processing algorithm. It should be appreciated that in at least one embodiment, step 620 may be omitted.

And it should be appreciated that in at least one embodiment there may be multiple predetermined thresholds associated with step 620—depending on the circumstances and upon the vehicle lamp being evaluated. In the vehicle headlamp example, one predetermined threshold may be associated with a vehicle headlamp high beam, and another predetermined threshold may be associated with a vehicle headlamp low beam. By having different predetermined thresholds for the high and low beams, it may be possible to determine a degradation of one when it is not possible to determine a degradation of the other. For example, since the luminance of a headlamp high beam is substantially greater than that of a headlamp low beam, the predetermined threshold (in step 620) could be higher for determining degradation performance of the headlamp high beam than that of the headlamp low beam.

In step 625, the ECU 16 evaluates a region of interest in the video sample to determine a lamp image intensity or a value of light intensity associated with the vehicle headlamp 30 (e.g., again using the image processing algorithm). For example, the camera F may be positioned so that at least a portion of the pixels on its image sensor capture the region of interest. As discussed above, the primary region of interest may include an image of at least part of the vehicle lamp 30 itself (e.g., see FIG. 2). And in at least one embodiment, the lamp image intensity determined in step 625 is an intensity in the primary region of interest. For instance, continuing with the grayscale example described above, in one embodiment, the lamp image intensity is a summation of the luminance values (or relative lightness/darkness values) of a group of pixels in or associated with the primary region of interest. Again, this is merely one implementation, and others exist (e.g., analogous techniques again could be used in color or other implementations). This determined lamp image intensity will be compared to another threshold, as discussed below in step 630.

It also should be appreciated that when the lamp image intensity is determined, the light intensity in the secondary region of interest could be considered instead of or in addition to the light image intensity in the primary region of interest. This may be determined or calculated in a similar fashion. Non-limiting examples of the secondary region of interest (with respect to headlamp 30) include a portion of an image associated with an area into which light should be present, including light: that is visible due to dust or fog in the air, that is visible due to a reflection off of the ground in front of vehicle 12, that is visible due to a reflection off of the other objects near the front of vehicle (e.g., other vehicles, infrastructure, etc.), or that is visible due to a reflection off of the bumper or body of the vehicle 12. Thus in step 625, the processor 84 in ECU 16 may analyze the light image intensity of the primary region of interest of the video sample, the secondary region of interest, or both to determine an associated lamp image intensity.

It should be appreciated that when the information evaluated comprises multiple images, a determination of lamp image intensity may be similar to the determination described above regarding overall image intensity. For example, the lamp image intensity of the primary region of interest for each image may be determined and averaged. Once a lamp image intensity value has been determined, the method 600 proceeds to step 630.

In step 630, the value of the lamp image intensity in the video sample is compared to another predetermined threshold associated with a minimum intensity. In at least one embodiment, the value of this predetermined threshold may be associated with the primary region of interest of an illuminated vehicle headlamp 30 (e.g., projecting a high beam or low beam). If the measured value of the lamp image intensity is not greater than the predetermined minimum intensity threshold, the ECU 16 may determine an indication or criteria which suggests that the vehicle headlamp performance is degraded—e.g., that the vehicle headlamp 30 is not providing the expected luminance. When this criteria has been determined, the method proceeds to step 640. Alternatively, when the lamp image intensity value is greater than or equal to the predetermined minimum intensity threshold, then the ECU 16 determines that the headlamp 30 is not degraded or is operating properly. When no degradation is determined, then method 600 proceeds to step 635 and thereafter loops back to step 615.

In step 635, the ECU 16 may pause, delay, or otherwise suspend the process of determining a degradation in the vehicle lighting system 18 for a period of time before proceeding to step 615 again (e.g., at least with respect to the headlamp 30). In at least one embodiment, it may be desirable to not continuously run the loop of steps 615-635. The period of suspension may be less than an hour, several hours, a day, until the next ignition cycle, etc., just to name a few non-limiting examples. In at least one embodiment, step 635 may be omitted and step 630 may proceed directly to step 615.

When in step 630, a criteria has been determined, then in step 640, the ECU 16 may increment a criteria counter (e.g., by ‘1’)—e.g., each increment of the counter indicating additional criteria. The counter may be another countermeasure against providing the vehicle user false positive indications of a vehicle headlamp degradation. As will be explained below in step 645, a predetermined quantity of criteria may be required before a degradation is determined by and a corresponding output signal provided from the processor 84.

In step 645, the ECU 16 may compare the total number of summed criteria (e.g., the counter value) to a predetermined quantity associated with a malfunction or degradation in headlamp performance. If the counter value is less than the predetermined quantity—then even though the processor 84 has detected lamp degradation criteria—no headlamp performance degradation will be determined. In this instance, the method 600 loops back to step 615 and repeats at least some of steps 615-645. However, if the counter value is greater than or equal to the predetermined quantity, then the processor 84 determines a headlamp performance degradation and proceeds to step 650. Therefore in order for the ECU 16 to determine a degradation (and alert the vehicle user) in at least one embodiment, a certain quantity of video samples previously will have been evaluated as having a lamp image intensity value (in the primary region of interest) that is less than or equal to the predetermined threshold (of step 630).

A determination of degradation may mean that the headlamp 30 has failed entirely (e.g., burnt out) or experienced some degree of performance degradation (e.g., the luminance of the headlamp 30 is less than a threshold). Or in some embodiments, the ECU 16 may determine that the low beam functionality is operating properly, but the high beam functionality has malfunctioned (or vice-versa).

The ECU 16 may measure a time duration instead of or in addition to using the counter in steps 640-645. In the current headlamp example, the ECU 16 alternatively could determine a degradation based on a lamp image intensity (in the primary region of interest) that is less than or equal to the predetermined threshold (in step 630) for a predetermined time duration (e.g., two or more minutes). Or for example, the predetermined quantity counted in steps 640-645 may be equivalent to two or more minutes of time. Skilled artisans will appreciate the relationship between a time duration and a quantity of images (or video samples)—especially where the number of frames per video sample and the refresh rate of the camera 14 (e.g., the frames per second) is known. In this instance, if the ECU determines a low lamp image intensity for the predetermined duration of time, then in step 645, the method proceeds to step 650. And if the lamp image intensity value remains low less than the predetermined duration (or is not low at all), then the method loops back to step 615, as described above.

In step 650, the ECU 16 provides an output in the form of an alert signal in response to the degradation determined in step 645. This alert signal may be an electrical signal, an optical signal, short range wireless signal, etc. and may be sent to at least one of the vehicle control modules 26 which in turn provides a suitable alert to the vehicle user (e.g., via the instrument panel 22 and/or audio system 24). Of course, the alert signal could be sent directly to the instrument panel 22 or audio system 24 from the ECU 16 as well. Once received by the instrument panel 22 and/or audio system 24, a visual alert, audible alert, or combination thereof may be provided to the vehicle user. Following step 650, the method 600 ends.

As discussed above, the method 600 used the vehicle headlamp 30 as an example only. Thus, it should be appreciated that the vehicle camera system 10 may determine a degradation at any suitable lamp 30-68. Further, the ECU 16 may store numerous predetermined thresholds associated with each different lamp image intensity (for use in step 630). For example, the stop lamps 66-68 may have predetermined thresholds different than the headlamps 30-32; the position lamps 46-48 and 62-64 may have predetermined thresholds different than the stop lamps 66-68, etc.

Similarly, for each of the lamps 30-68, at least two sets of lamp image intensity thresholds may be stored in ECU memory 82—i.e., a first predetermined threshold for the primary region of interest and a second predetermined threshold for the secondary region of interest. Furthermore, additional image processing techniques may be required for determining a degradation solely based on a secondary region of interest—e.g., for at least the reasons that the object(s) which reflect the vehicle lamp's projected light can be constantly changing as the vehicle changes location—e.g., objects such as the roadway, trees, signs, other vehicles, etc.

When the ECU 16 monitors for a degradation, other techniques may be required when the vehicle lamp is not illuminated for long durations of time, or is used less regularly. For example, turn-signal lamps 54-60 and stop lamps 66-68 are typically in the actuated state for short durations (e.g., typically seconds). A turn-signal lamp example is illustrative. For example, one or two video samples of the turn-signal lamp 58 could be captured by camera DS while the lamp 58 is in the actuated state (e.g., when it is supposed to be blinking). When the lamp image intensity value of the turn-signal lamp 58 is less than its predetermined threshold (step 630), then the processor may store the counter value in memory 82 (steps 640-645). Since the turn-signal lamp quickly may return to the off or not actuated state, method 600 may need to loop back to step 610 (e.g., instead of step 615)—e.g., waiting for the next instance the turn-signal is actuated.

Since the turn-signal lamp may be used relatively infrequently, the counter value(s) may be stored in non-volatile memory 82 (e.g., EEPROM) so that it is available following an ignition cycle. In at least one implementation, the predetermined quantity (step 645) associated with the turn-signal lamps 54-60 may be five; however, other implementations are possible. Similarly, the predetermined quantity (step 645) associated with the stop lamps 66-68 may be five; however again, other implementations are possible.

Still other embodiments also exist. For example, as previously discussed, image data from two or more cameras could be used to evaluate the performance of one or more of the vehicle lamps (20-72). For example, front and side cameras F and DS could both receive image data from one or more of the vehicle lamps (e.g., front position lamp 46 and/or vehicle headlamp 54). Front position lamp 46 is illustrative. The ECU 16 could process image data from both cameras 46 and 54 using any portion of the method described above and determine the lamp performance of the position lamp 46. In at least one embodiment, a degradation in lamp performance may be determined only when processed image data from both cameras F and DS indicate the degradation. Of course, this is merely an example; using image data from other cameras and/or regarding other vehicle lamps is also possible—e.g., again, depending also on the design (e.g., shape) of the vehicle.

The vehicle camera system described herein (e.g., the ECU 16 and one or more cameras 14) may be provided from a supplier to a vehicle manufacturer, and the manufacturer may install and assemble camera system(s) into multiple vehicle(s). Thus, the specific arrangement and orientation of the vehicle cameras 14 may vary according to the design (or shape) of the vehicle being assembled. The communication interface between the ECU 16 and the camera(s) 14 may or may not be provided by the supplier. For example, the manufacturer may elect to utilize existing vehicle communication harnesses, wiring, short range wireless signaling, etc. to establish communication between the cameras F, R, DS, PS and ECU 16.

In other implementations, the vehicle camera system 10 could be an after-market product which is installed by the vehicle user or a third party. The ECU 16 may be coupled to the camera(s) 14 via an OBD II port or the like to receive one or more control module signals.

Thus, there has been described an optical light sensing system which can be used to determine a degradation in performance of external vehicle lighting units or lamps. The light sensing system may include an electronic control unit (ECU) and one or more cameras. Using image processing techniques, the ECU may be configured to determine the relative intensity of a vehicle lamp or projected light therefrom. Based on this intensity, the ECU may determine whether the lamp is properly illuminated or experiencing at least some threshold amount of degradation. If the ECU determines threshold degradation, the ECU may provide a user of the vehicle an alert or notification.

It should be understood that all references to direction and position, unless otherwise indicated, refer to the orientation of the parking brake actuator illustrated in the drawings. In general, up or upward generally refers to an upward direction within the plane of the paper and down or downward generally refers to a downward direction within the plane of the paper.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A system to detect or determine vehicle lamp performance, comprising:
a first optical sensor having a field of view which includes the location of a vehicle lamp or into which light from a vehicle lamp is emitted, the optical sensor providing an output indicative of vehicle lamp performance; and
a controller in communication with the first optical sensor to receive the output, the controller including at least one processor adapted to analyze the optical sensor output and provide a control output at least when the optical sensor output is indicative that the vehicle lamp performance is below a threshold.

2. The system of claim 1, wherein the first optical sensor is a camera.

3. The system of claim 1, wherein the controller further comprises a non-transitory computer readable memory having instructions stored thereon for determining whether lamp performance is below the threshold and providing an alert signal from the controller to vehicle electronics, wherein the instructions comprise:
receiving an image from the first optical sensor comprising a region of interest that includes the vehicle lamp or the light emitted from the vehicle lamp;
using the image, comparing an intensity associated with the region of interest to the threshold; and
when the intensity is less than or equal to the threshold, then providing the alert signal.

4. The system of claim 3, wherein the instructions further comprise repeatedly determining that the intensity is less than or equal to the threshold, and in response to the repeated determination, then providing the alert signal.

5. The system of claim 3, wherein the instructions further comprise receiving a plurality of images from the first optical sensor, using the plurality of images, comparing the intensity associated with the region of interest of the plurality of images to the threshold, and providing the alert signal when the intensity of the plurality of images is less than or equal to the threshold.

6. The system of claim 1, further comprising a second optical sensor having a field of view which includes the location of the vehicle lamp or into which light from the vehicle lamp is emitted, the at least one processor adapted to analyze the output of the first and second optical sensors and provide the control output at least when the output of the first and second optical sensors is indicative that the lamp performance is below the threshold.

7. The system of claim 1, wherein the field of view (FOV) is greater than 180 degrees.

8. The system of claim 1, wherein the at least one processor further is adapted, prior to analyzing the optical sensor output, to determine that an overall intensity of an image of the optical sensor output is less than a second threshold.

9. The system of claim 1, wherein the vehicle lamp is one of a vehicle head lamp, a vehicle fog lamp, a vehicle reversing lamp, a vehicle position lamp, a vehicle side-marker lamp, a vehicle turn-signal lamp, or a vehicle brake lamp.

10. A system to detect or determine vehicle lamp performance, comprising:
a plurality of optical sensors adapted to monitor an area around a vehicle which includes at least one vehicle lamp or light emitted therefrom into the area around the vehicle; and
a controller that is couplable to the plurality of optical sensors, the controller comprising memory and at least one processor, wherein the memory is a non-transitory computer readable medium having instructions stored thereon for determining at the controller a degradation in vehicle lamp performance and providing an alert signal from the controller, wherein the instructions comprise:
receiving one or more images from one of the plurality of optical sensors, at least a portion of the one or more images comprising a region of interest associated with the at least one vehicle lamp or the light emitted therefrom;
determining an overall intensity of the one or more images; and
when the overall intensity is less than a predetermined threshold, then:
using the one or more images, determining whether vehicle lamp performance is degraded; and
when vehicle lamp performance is degraded, then providing the alert signal.

11. The system of claim 10, wherein the instructions further comprise: prior to receiving the one or more images from the one of the plurality of optical sensors, receiving an indication from the vehicle that the at least one vehicle lamp is actuated to an ON state.

12. The system of claim 10, wherein the instructions further comprise: prior to providing the alert signal, determining at least twice that vehicle lamp performance is degraded using different one or more images.

13. The system of claim 10, wherein the at least one vehicle lamp is one of a vehicle head lamp, a vehicle fog lamp, a vehicle reversing lamp, a vehicle position lamp, a vehicle side-marker lamp, a vehicle turn-signal lamp, or a vehicle brake lamp.

14. A method of determining a vehicle lamp performance at a controller in a vehicle, comprising the steps of:
receiving at the controller at least one image from an optical sensor wherein the at least one image comprises a region of interest associated with a vehicle lamp;
determining at the controller an intensity of the region of interest;
comparing the determined intensity to a threshold; and
providing an alert signal from the controller when the intensity is below the threshold.

15. The method of claim 14, further comprising: prior to determining the intensity, receiving an indication at the controller that the vehicle lamp is actuated ON.

16. The method of claim 12, wherein the vehicle lamp is one of a vehicle head lamp, a vehicle fog lamp, a vehicle reversing lamp, a vehicle position lamp, a vehicle side-marker lamp, a vehicle turn-signal lamp, or a vehicle brake lamp.

17. The method of claim 12, wherein the alert signal is configured by the controller to be readable by vehicle electronics which provide visual or audible alerts.

18. The method of claim 12, wherein, prior to providing the alert signal from the controller, determining that the intensity is less than the threshold for a predetermined plurality of images or for a predetermined duration of time.
